(19) United States
(12) Patent Application Publication
(10) Pub. No.: US 2026/0273853 A1
(43) Pub. Date: Sep. 17, 2026

(54) TEXTILE FIBERS BLENDING SYSTEM AND METHOD

(71) Applicant: 14787285 Canada Inc. dba Nuria Scientific, Thorold (CA)

(72) Inventors: Nicholas Ledra, St Catherines (CA); Wankei Wan, Thorold (CA)

(21) Appl. No.: 19/557,828

(22) Filed: Mar. 5, 2026

Related U.S. Application Data
(60) Provisional application No. 63/771,659, filed on Mar. 14, 2025.

(51) Int. Cl. B29C 64/314; B33Y 30/00; B33Y 40/10; B29K 1/00; B29K 67/00; B29K 105/14; B29K 105/26; B29K 311/10

(52) U.S. Cl. CPC B29C 64/314; B33Y 30/00; B33Y 40/10; B29K 2001/00; B29K 2067/00; B29K 2105/14; B29K 2105/26; B29K 2311/10; B29K 2995/0093

(57) ABSTRACT

The present disclosure provides a system to produce a blended textile material. The system comprises a fiber preparation unit processing a mixture comprising at least one natural fiber selected from Alpaca wool, Vicuna wool, Llama wool, goat wool, sheep wool, lamb wool, and cotton, and at least one synthetic fiber selected from virgin polyethylene terephthalate and recycled polyethylene terephthalate. A blending unit pelletizes the mixture and forms fiber blends for extrusion. An extrusion unit receives the fiber blends from the blending unit and co-extrudes the fiber blends to form a hollow fiber structure comprising a combination of the natural fiber and the synthetic fiber. A 3D bio-printing unit deposits a material comprising polyester and cellulose onto a surface of the hollow fiber structure to modify surface properties.

### CROSS REFERENCE TO RELATED APPLICATION

This application claims benefit of priority to U.S. Provisional Application Serial Number 63/771,659, filed March 14, 2025, the entire contents of which is incorporated herein by reference for all purposes.

### TECHNICAL FIELD

The present disclosure generally relates to textile manufacturing. Further, the present disclosure particularly relates to a system to produce a blended textile material comprising a combination of natural fibers and synthetic fibers.

### BACKGROUND

The textile industry utilises various natural and synthetic fibres to manufacture garments with desired properties for example water repellence, heat retention, heat dissipation and breathability. Wool, derived from animals for example sheep, alpacas and camels, is commonly used for such applications due to inherent insulation and moisture-wicking properties. Various techniques have been developed to improve the properties of wool to meet the requirements of different climatic conditions and consumer preferences.

Various blending techniques are employed in textile manufacturing to combine wool with other fibres to improve mechanical strength, durability, elasticity and other desirable characteristics. Conventional wool-blend fabrics integrate fibres for example cotton, acrylic, nylon, silk and polyester. Each of said materials influences the resultant fabric properties. Cotton improves softness and breathability, acrylic improves durability and affordability, nylon imparts elasticity and abrasion resistance, while silk contributes to sheen and smooth texture. Synthetic fibres, comprising polyester, are commonly utilised due to cost-effectiveness and improved wear resistance.

Blending of camelid wool with synthetic or natural fibres is widely practised to improve garment longevity and reduce dependence on pure wool. Conventional blends incorporate cotton, acrylic or other types of wool. Acrylic-wool blends provide improved durability and cost reduction but lack sufficient heat retention and moisture-wicking properties. Cotton-wool blends improve breathability and softness but demonstrate reduced water repellence and structural integrity over prolonged use. Other wool blends, for example merino-camelid combinations, offer improved thermal regulation but do not significantly improve the durability of garments.

Blended wool fabrics present various limitations due to the properties of the fibres employed. Acrylic-containing blends exhibit reduced moisture-wicking capabilities and may retain odours due to lower breathability. Cotton-based blends show increased absorbency, leading to reduced water repellence and prolonged drying time. Other wool blends, though capable of maintaining thermal properties, fail to provide substantial improvement in durability and longevity. The absence of effective materials which improve both durability and performance parameters for example water repellence, heat retention and breathability necessitates further improvement in textile blending techniques.

Prior textile manufacturing techniques involve different methods of combining wool with synthetic and natural fibres. US Patent No. 4,947,782 discloses a method of blending wool with polyester to improve elasticity and reduce shrinkage. However, said method results in a fabric with decreased breathability and increased rigidity. Another known method is described in US Patent No. 6,319,616, which outlines a process of combining wool with acrylic to increase wear resistance. Nevertheless, the resultant material demonstrates compromised water repellence and reduced thermal insulation. European Patent EP1346793 discusses a technique of wool-silk blending for improved texture and appearance. However, said technique does not address the issue of increased wool consumption and garment longevity.

Other prior arts disclose techniques of wool fibre treatment and blending to achieve various functional benefits. US Patent No. 7,008,932 provides a process of treating wool with synthetic polymers to improve water resistance. However, the polymer-treated wool lacks sufficient breathability and is susceptible to degradation under prolonged use. Another reference, US Patent No. 9,645,325, discloses a fabric comprising wool and elastane to improve stretchability and comfort. Nevertheless, said fabric does not provide significant improvement in durability and is associated with increased material fatigue over extended wear cycles.

The deficiencies in prior techniques comprise a failure to optimise wool utilisation while maintaining important performance characteristics. Conventional wool blends do not enable a significant reduction in wool usage without compromising on insulation, water repellence and breathability. The introduction of various synthetic fibres improves durability to an extent but often at the cost of reduced moisture management and thermal regulation. Existing methods of blending do not incorporate polyethylene terephthalate (PET) in camelid wool-based garments, limiting the benefits of increased longevity and structural integrity.

Furthermore, currently known wool blend fabrics exhibit a lack of synergy in material properties, leading to trade-offs in important characteristics for example breathability, heat retention and water repellence. Prolonged exposure to environmental conditions results in deterioration of fabric strength, affecting the overall lifespan of garments. The absence of an effective fibre blending technique which optimises wool consumption while simultaneously improving performance and durability necessitates further developments in textile manufacturing.

In light of the above discussion, there exists an urgent need for solutions which overcome the problems associated with conventional systems and/or techniques for optimising the water repelling, heat retention and dissipation and breathability properties of wool while enabling less wool to be used and improving durability of garments.

### SUMMARY

An objective of the present disclosure is to provide a system to produce a blended textile material by combining natural fibers and synthetic fibers to improve fabric durability, water repellency, and breathability while maintaining reduced wool consumption. The system of the present disclosure aims to improve fiber processing techniques to optimize fiber alignment, blending, and surface modification for improved textile performance.

In an aspect, the present disclosure provides a system to produce a blended textile material. A fiber preparation unit processes a mixture comprising at least one natural fiber selected from Alpaca wool, Vicuna wool, Llama wool, goat wool, sheep wool, lamb wool, and cotton, and at least one synthetic fiber selected from virgin polyethylene terephthalate and recycled polyethylene terephthalate. A blending unit pelletizes the mixture and forms fiber blends for extrusion. An extrusion unit receives the fiber blends from the blending unit and co-extrudes the fiber blends to form a hollow fiber structure comprising a combination of the natural fiber and the synthetic fiber. A 3D bio-printing unit deposits a material comprising polyester and cellulose onto a surface of the hollow fiber structure to modify surface properties.

Further, the system of the present disclosure processes the mixture comprising 1-90% of the natural fiber and 1-99% of the synthetic fiber to optimize textile composition based on predefined requirements. A fiber alignment unit processes recycled polyester material by cutting, crimping, and aligning fibers with the natural fiber to improve fiber integration. A material treatment unit applies hydrophobic treatment over the fiber blends to improve water repellency. The extrusion unit forms a multi-layered fiber structure, wherein at least one layer comprises the natural fiber and at least one layer comprises the synthetic fiber. The extrusion unit also processes fiber blends into a filamentous structure suitable for weaving, knitting, or non-woven textile formation.

Moreover, the fiber preparation unit comprises a pre-treatment section for cleaning, carding, or scouring the natural fiber before blending with the synthetic fiber. The fiber preparation unit regulates the proportion of natural and synthetic fibers based on predefined textile performance parameters. The blending unit incorporates a pre-conditioning chamber which applies controlled humidity and temperature to the natural fiber prior to blending to improve fiber compatibility. A surface treatment unit is operatively connected to at least one of the 3D bio-printing unit or the extrusion unit, wherein the surface treatment unit applies a surface modification process to at least one of a polyester fiber, a wool fiber, a cellulose fiber, or a textile substrate.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein.

Embodiments of the present disclosure will now be described, by way of example only, with reference to the following diagrams.

FIG. 1 illustrates a system 100 to produce a blended textile material, in accordance with various implementations of the present disclosure; and

FIG. 2 illustrates a flow diagram of the system 100 for producing the blended textile material in accordance with embodiments of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

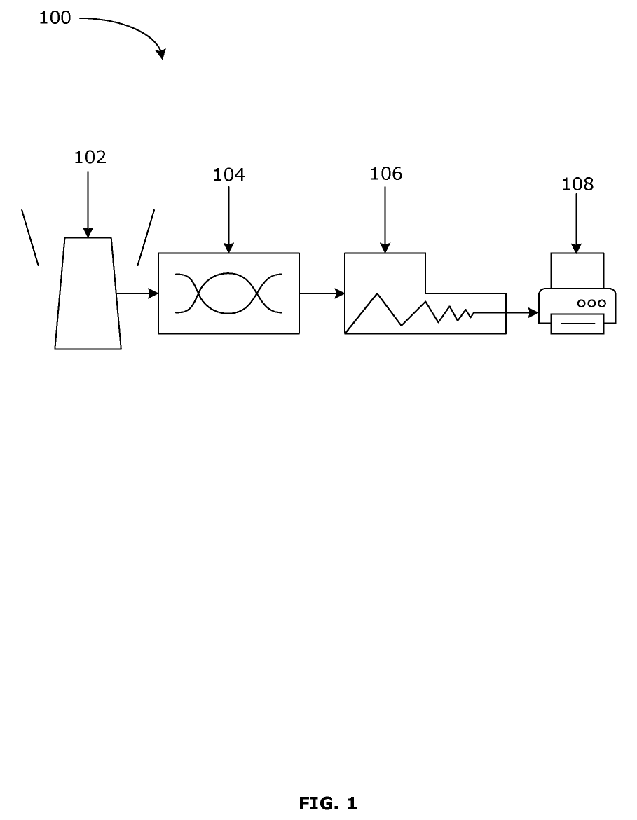

FIG. 1 illustrates a system 100 to produce a blended textile material, in accordance with various implementations of the present disclosure. The system 100 comprises a fiber preparation unit 102 to process a mixture comprising at least one natural fiber selected from a group consisting of Alpaca wool, Vicuna wool, Llama wool, goat wool, sheep wool, lamb wool, and cotton, and at least one synthetic fiber selected from virgin polyethylene terephthalate and recycled polyethylene terephthalate. The fiber preparation unit 102 receives raw fiber materials and subjects the materials to an initial cleaning process to remove impurities, for example dirt, grease, and other contaminants. The fiber preparation unit 102 performs a mechanical opening process which separates entangled fibers, enabling uniform distribution of individual fiber components. A carding mechanism in the fiber preparation unit 102 aligns the fibers to improve uniformity and optimize blending efficiency. A combing mechanism further refines the fiber structure by removing shorter fiber fragments, resulting in an improved fiber length distribution. The fiber preparation unit 102 incorporates a weighing mechanism which determines the proportion of natural fiber and synthetic fiber in the mixture, assuring the desired blend ratio which is maintained before further processing. A lubrication system within the fiber preparation unit 102 applies a conditioning agent to the fiber mixture, facilitating smooth processing in subsequent stages. The fiber preparation unit 102 comprises a conveyance mechanism which transports the processed fiber mixture to a blending unit 104 for further processing.

In an embodiment, the system 100 comprises the blending unit 104 which operatively coupled to the fiber preparation unit 102. The blending unit 104 pelletizes the mixture and forms fiber blends for extrusion. A metering system within the blending unit 104 regulates the feeding of processed fiber material to maintain consistency in the blending process. A compression mechanism applies controlled pressure to densify the fiber mixture into pelletized structures, assuring uniform composition throughout the processed material. A temperature control system within the blending unit 104 regulates thermal conditions to prevent degradation of natural fiber while allowing proper fusion with synthetic fiber components. A mixing chamber in the blending unit 104 facilitates homogeneous distribution of fiber components, eliminating inconsistencies in fiber dispersion. The blending unit 104 incorporates a discharge system which transfers the blended fiber material to an extrusion unit 106.

In an embodiment, the system 100 comprises the extrusion unit 106 which receives the fiber blends from the blending unit 104 and co-extrudes the fiber blends to form a hollow fiber structure. The hollow fiber structure comprises a combination of the natural fiber and the synthetic fiber. A feed mechanism within the extrusion unit 106 directs the pelletized fiber blends into an extrusion chamber for processing. A heating system within the extrusion unit 106 applies controlled thermal energy to induce softening of the synthetic fiber component while maintaining the structural integrity of the natural fiber component. A die assembly within the extrusion unit 106 shapes the molten mixture into a continuous fiber strand with a hollow core, improving mechanical properties of the resultant fiber structure. A cooling mechanism in the extrusion unit 106 stabilizes the extruded hollow fiber structure by regulating the cooling rate, preventing defects, for example warping or shrinkage. A take-up mechanism in the extrusion unit 106 collects the formed hollow fiber structure and transports the material to a 3D bio-printing unit 108.

In an embodiment, the system 100 comprises the 3D bio-printing unit 108 which is operatively connected to the extrusion unit 106. The 3D bio-printing unit 108 deposits a material comprising polyester and cellulose onto a surface of the hollow fiber structure to modify surface properties. A deposition head in the 3D bio-printing unit 108 applies a controlled layer of polyester and cellulose mixture to the hollow fiber structure. A nozzle control system within the 3D bio-printing unit 108 regulates the deposition pattern, assuring uniform application across the fiber surface. A curing system within the 3D bio-printing unit 108 enables adhesion of the deposited material by applying thermal or ultraviolet treatment. A delivery mechanism within the 3D bio-printing unit 108 transfers the treated fiber structure for subsequent processing, comprising fabric formation or textile finishing.

In an exemplary aspect, the system 100 for producing the blended textile material comprises the fiber preparation unit 102, the blending unit 104, the extrusion unit 106, and the 3D bio-printing unit 108. The fiber preparation unit 102 processes a mixture consisting of 60% Alpaca wool and 40% recycled polyethylene terephthalate, wherein said fiber preparation unit 102 removes impurities, mechanically separates fibers, and applies a lubricating agent to facilitate further processing. The weighing mechanism within said fiber preparation unit 102 provides a consistent blend ratio before transferring the fiber mixture to the blending unit 104. The blending unit 104 receives the fiber mixture and pelletizes the mixture under a controlled pressure of 150 MPa, densifying the mixture into uniform pellets. A warming system within said blending unit 104 maintains a temperature of 200°C to allow partial fusion of the synthetic fiber while preserving the natural fiber structure. The mixing chamber within said blending unit 104 enables homogeneous dispersion of fiber components before transferring the blended fiber material to the extrusion unit 106. The extrusion unit 106 receives the pelletized fiber blends and co-extrudes the blends into a hollow fiber structure, wherein a heating system within the said extrusion unit 106 maintains a temperature of 280°C to soften the synthetic fiber while maintaining the integrity of the natural fiber. The die assembly within said extrusion unit 106 forms the hollow fiber structure with an outer diameter of 50 micrometers and an inner core diameter of 20 micrometers. The cooling mechanism within said extrusion unit 106 stabilizes the fiber structure, and the take-up mechanism within said extrusion unit 106 winds the formed fiber onto spools for further processing. The 3D bio-printing unit 108 deposits a material comprising 70% polyester and 30% cellulose onto a surface of the hollow fiber structure, wherein the nozzle control system within said 3D bio-printing unit 108 regulates the deposition at a rate of 0.5 mm per second. The curing system within said 3D bio-printing unit 108 applies ultraviolet treatment to enhance adhesion and durability, and the treated fiber is processed into fabric for outdoor jackets with improved durability, water resistance, and thermal insulation.

In an embodiment, the mixture processed by the fiber preparation unit 102 may comprise 1-90% (selected from distinct ranges for example 1%-10%, 11%-21%, 22%-40%,41%- 43%, 44%-50%, 51%-73%, 74%-90%) of the natural fiber and 1-99% (selected from distinct ranges for example 1%-15%, 16%-27%, 28%-40%, 41%- 47%, 48%-55%, 56%-73% and 74%-90%) of the synthetic fiber. The mixture composition is selected based on specific textile properties, for example durability, water repellency, breathability, and thermal insulation. For example, a mixture containing 30% Alpaca wool and 70% recycled polyethylene terephthalate produces a lightweight, warm, and water-resistant fabric suitable for outdoor garments. In another example, a mixture containing 80% sheep wool and 20% virgin polyethylene terephthalate provides improved elasticity and structural stability for upholstery applications. A weighing system within the fiber preparation unit 102 regulates the proportion of each fiber to maintain consistent blending throughout processing. A feedback control mechanism adjusts the fiber ratio based on predefined textile specifications. A conveyance system within the fiber preparation unit 102 assures uniform feeding of the fiber mixture into the blending unit 104 for further processing.

In an embodiment, the system 100 for producing the blended textile material may comprise a fiber alignment unit that processes recycled polyester material by cutting, crimping, and aligning fibers with a natural fiber to improve fabric quality. A cutting mechanism within the fiber alignment unit reduces recycled polyester material into uniform staple lengths ranging from 20 to 100 millimeters (selected from distinct ranges for example 20 to 30 millimeters, 21 to 40 millimeters, 41 to 50 millimeters and 51 to 90 millimeters). A crimping system introduces controlled crimps into the synthetic fiber to improve mechanical interlocking with the natural fiber during blending. An alignment mechanism arranges fibers in a parallel orientation, assuring uniform distribution before entering the blending unit 104. For example, in a mixture containing 50% goat wool and 50% recycled polyethylene terephthalate, the fiber alignment unit adjusts crimping parameters to achieve optimal fiber cohesion. A fiber tensioning system regulates fiber alignment to prevent inconsistencies in downstream processing. A transfer system conveys aligned fibers into the blending unit 104 for pelletization and extrusion.

In an embodiment, the system 100 for producing the blended textile material may comprise a material treatment unit applies hydrophobic treatment over fiber blends to improve water repellency. A spray-coating system within the material treatment unit distributes a hydrophobic agent, for example a fluorocarbon-based or silicone-based compound, onto the fiber blends before extrusion. The curing system applies controlled thermal exposure at 150°C to bond the hydrophobic agent to fiber surfaces. For example, in a blended fiber structure containing 40% Vicuna wool and 60% recycled polyethylene terephthalate, a fluoropolymer treatment provides improved resistance to moisture penetration. A plasma treatment mechanism modifies fiber surface energy before hydrophobic application to improve adhesion. A drying system eliminates excess moisture content from the treated fiber blends, assuring uniform coating. A transportation mechanism transfers the treated fiber blends to the extrusion unit 106 for further processing.

In an embodiment, the extrusion unit 106 may form a multi-layered fiber structure, wherein at least one layer comprises the natural fiber and at least one layer comprises the synthetic fiber. A feed control system directs fiber blends into an extrusion die structured for multi-layer formation. A layering mechanism arranges fiber compositions into distinct structural layers before extrusion. A heating up system maintains processing temperatures between 250°C and 280°C to assure controlled fusion of synthetic components while preserving natural fiber integrity. For example, an extrusion process involving 60% lamb wool in an outer layer and 40% virgin polyethylene terephthalate in an inner layer produces a fabric with improved thermal insulation and mechanical strength. A cooling system stabilizes the multi-layered structure, preventing deformation. A take-up system collects the extruded fiber structure for subsequent bio-printing and surface modification.

In an embodiment, the extrusion unit 106 processes the fiber blends into a filamentous structure suitable for weaving, knitting, or non-woven textile formation. The extrusion unit 106 receives the fiber blends and applies heat and pressure to induce softening before forcing the material through spinnerets to form continuous filaments. The extrusion unit 106 regulates temperature, pressure, and extrusion speed to achieve uniform filament thickness. Cooling mechanisms solidify the filaments immediately after extrusion, while drawing mechanisms align and strengthen the filaments to improve mechanical properties. The extrusion unit 106 includes surface treatment applications that modify adhesion, texture, or dye affinity. Multiple extrusion channels facilitate co-extrusion of different fiber blends for composite filament formation. Integrated sensors and controllers monitor and adjust processing parameters in real time.

In an embodiment, the fiber preparation unit 102 may comprise a pre-treatment section for cleaning, carding, or scouring the natural fiber before blending with the synthetic fiber. A washing system removes natural impurities, for example grease and dirt from raw fiber material. The carding mechanism aligns individual fibers, reducing entanglement and improving blending efficiency. A scouring process eliminates residual contaminants to improve fiber purity. For example, in a processing sequence involving 50% Alpaca wool and 50% recycled polyethylene terephthalate, a high temperature scouring treatment removes lanolin from the wool component, improving dye absorption in subsequent textile processing. The transfer system conveys pre-treated fibers into the blending unit 104 for further processing.

In an embodiment, the fiber preparation unit 102 may regulate the proportion of natural and synthetic fibers based on predefined textile performance parameters. A control system monitors fiber blending ratios in current time, adjusting feed rates to maintain target composition. A feedback loop mechanism processes sensor data related to fiber weight, density, and moisture content. For example, a processing sequence targeting high thermal insulation properties adjusts the fiber ratio to 80% Vicuna wool and 20% virgin polyethylene terephthalate.

In an embodiment, the blending unit 104 may incorporate a pre-conditioning chamber which applies controlled humidity and temperature to a natural fiber before blending to improve fiber compatibility. A humidity control system maintains moisture levels between 5% and 15% to prevent excessive brittleness or fiber degradation. A temperature control mechanism regulates processing conditions within a range of 50°C to 100°C (selected from distinct ranges such as 50°C to 60°C, 65°C to 70°C, 72°C to 80°C and 85°C to 95°C) to optimize fiber pliability. For example, in a fiber blend comprising 40% Llama wool and 60% recycled polyethylene terephthalate, pre-conditioning at 70°C and 10% humidity improves inter-fiber adhesion, reducing processing inconsistencies. A material agitation system assures uniform exposure to pre-conditioning treatment before blending.

In an embodiment, the system 100 for producing the blended textile material may comprise a surface treatment unit which is operatively connected to at least one of the 3D bio-printing unit 108 or the extrusion unit 106, wherein the surface treatment unit applies a surface modification process to at least one of a polyester fiber, a wool fiber, a cellulose fiber, or a textile substrate. A plasma treatment mechanism modifies fiber surface energy, improving dye uptake and coating adhesion. A chemical grafting process introduces reactive functional groups onto fiber surfaces to improve compatibility with finishing agents. For example, in a textile structure comprising 60% recycled polyethylene terephthalate and 40% cotton, an atmospheric plasma treatment improves moisture absorption properties. A roller-based coating system applies polymer dispersions onto textile surfaces to improve performance characteristics. The curing system stabilizes surface modifications under controlled temperature conditions.

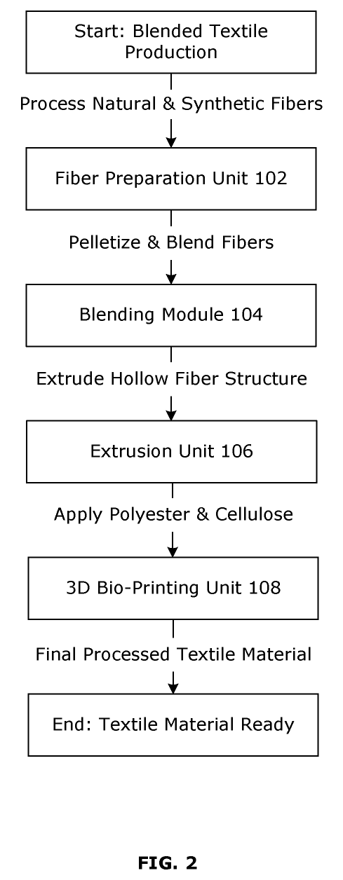

FIG. 2 illustrates a flow diagram of the system 100 for producing the blended textile material in accordance with embodiments of the present disclosure. The system 100 for producing the blended textile material for processing natural and synthetic fibers. A fiber preparation unit 102 processes a mixture comprising at least one natural fiber, for example Alpaca wool, Vicuna wool, Llama wool, goat wool, sheep wool, lamb wool, or cotton, along with at least one synthetic fiber, for example virgin polyethylene terephthalate or recycled polyethylene terephthalate. The processed fiber mixture is transferred to a blending module 104, which pelletizes and blends the fibers to assure uniform composition. The blended fiber material is then directed to an extrusion unit 106, where the fiber blends undergo co-extrusion to form a hollow fiber structure integrating both natural and synthetic fibers. A 3D bio-printing unit 108 receives the extruded hollow fiber structure and deposits a material comprising polyester and cellulose onto the fiber surface to modify surface properties for example durability, moisture resistance, and breathability. The final processed textile material is then ready for further textile applications, comprising fabric weaving, knitting, or non-woven textile formation. The diagram visually represents the sequential workflow of fiber processing, blending, extrusion, and surface modification for optimized textile material production.

In an embodiment, the system 100 for producing the blended textile material by integrating natural and synthetic fibers to improve fabric properties, for example durability, breathability, water repellency, and thermal regulation. The fiber preparation unit 102 processes a mixture comprising at least one natural fiber selected from Alpaca wool, Vicuna wool, Llama wool, goat wool, sheep wool, lamb wool, and cotton, and at least one synthetic fiber selected from virgin polyethylene terephthalate and recycled polyethylene terephthalate. The blending module 104, operatively coupled to the fiber preparation unit 102, pelletizes the mixture and forms fiber blends for extrusion. The extrusion unit 106 receives the fiber blends from the blending module 104 and co-extrudes the fiber blends to form a hollow fiber structure comprising a combination of the natural fiber and the synthetic fiber. The 3D bio-printing unit 108, operatively connected to the extrusion unit 106, deposits a material comprising polyester and cellulose onto a surface of the hollow fiber structure to modify surface properties. The mixture comprises 1-90% of the natural fiber and 1-99% of the synthetic fiber. The fiber alignment unit processes recycled polyester material by cutting, crimping, and aligning fibers with the natural fiber to improve fabric quality. The material treatment unit applies hydrophobic treatment over the fiber blends to improve water repellency. The extrusion unit 106 forms a multi-layered fiber structure, wherein at least one layer comprises the natural fiber and at least one layer comprises the synthetic fiber. The extrusion unit 106 processes the fiber blends into the filamentous structure suitable for weaving, knitting, or non-woven textile formation. The fiber preparation unit 102 comprises the pre-treatment module for cleaning, carding, or scouring the natural fiber before blending with the synthetic fiber. The fiber preparation unit 102 regulates the proportion of natural and synthetic fibers based on predefined textile performance parameters. The blending module 104 incorporates the pre-conditioning chamber which applies controlled humidity and temperature to the natural fiber prior to blending to improve fiber compatibility. The surface treatment unit, operatively connected to at least one of the 3D bio-printing unit 108 or the extrusion unit 106, applies a surface modification process to at least one of a polyester fiber, a wool fiber, a cellulose fiber, or a textile substrate.

What is claimed is:

1. A system to produce a blended textile material, comprising:
a fiber preparation unit processing a mixture including at least one natural fiber selected from the group comprising: Alpaca wool, Vicuna wool, Llama wool, goat wool, sheep wool, lamb wool, and cotton, and at least one synthetic fiber selected from the group comprising: virgin polyethylene terephthalate (PET) and recycled polyethylene terephthalate (rPET);
a blending module operatively coupled to the fiber preparation unit, wherein the blending module pelletizes the mixture and forms the fiber blends for extrusion;[an extrusion unit receiving the fiber blends from the blending module, wherein the extrusion unit co-extrudes the fiber blends to form a hollow fiber structure comprising a combination of the natural fiber and the synthetic fiber; and
a 3D bio-printing unit operatively connected to the extrusion unit, wherein the 3D bio-printing unit deposits a material comprising polyester and cellulose onto a surface of the hollow fiber structure to modify the surface properties.

2. The system of claim 1, wherein the mixture comprises 1-90% of the natural fiber and 1-99% of the synthetic fiber.

3. The system of claim 1, further comprising a fiber alignment unit configured to process recycled polyester material by cutting, crimping, and aligning the fibers with the natural fiber to enhance fabric quality.

4. The system of claim 1, further comprising a material treatment unit that applies hydrophobic treatment over the fiber blends to enhance water repellency.

5. The system of claim 1, wherein the extrusion unit forms a multi-layered fiber structure, wherein at least one layer comprises the natural fiber and at least one layer comprises the synthetic fiber.

6. The system of claim 1, wherein the extrusion unit processes the fiber blends into a filamentous structure suitable for weaving, knitting, or non-woven textile formation.

7. The system of claim 1, wherein the fiber preparation unit comprises a pre-treatment module for cleaning, carding, or scouring the natural fiber before blending with the synthetic fiber.

8. The system of claim 1, further comprising a surface treatment unit operatively connected to at least one of the 3D bio-printing unit or the extrusion unit, wherein the surface treatment unit applies a surface modification process to at least one of a polyester fiber, a wool fiber, a cellulose fiber, or a textile substrate.
